(19) United States
(12) Patent Application Publication
(10) Pub. No.: US 2015/0058011 A1
(43) Pub. Date: Feb. 26, 2015

(54) INFORMATION PROCESSING APPARATUS, INFORMATION UPDATING METHOD AND COMPUTER-READABLE STORAGE MEDIUM

(71) Applicants: Naoya MORITA, Kanagawa (JP); Satoshi Aoki, Kanagawa (JP); Shinya Miyazaki, Tokyo (JP); Kazutaka Murakami, Kanagawa (JP); Yasuko Hashimoto, Kanagawa (JP)

(72) Inventors: Naoya MORITA, Kanagawa (JP); Satoshi Aoki, Kanagawa (JP); Shinya Miyazaki, Tokyo (JP); Kazutaka Murakami, Kanagawa (JP); Yasuko Hashimoto, Kanagawa (JP)

(21) Appl. No.: 14/452,909

(22) Filed: Aug. 6, 2014

(30) Foreign Application Priority Data
Aug. 20, 2013 (JP) 2013-170607

(51) Int. Cl. G10L 15/02; G10L 15/04

(52) U.S. Cl. CPC G10L 15/02; G10L 15/04
USPC 704/236

(57) ABSTRACT

An information processing apparatus recognizes input data as character information formed by character strings each being in a predetermined unit based on information relating to a character string as a recognition target, and performs processing based on the recognized character information. The apparatus includes an input information receiver that receives input information capable of being processed as characters; an input information dividing unit that divides the received input information into character strings each being in a predetermined processing unit; a popularity level calculating unit that calculates a popularity level based on history of an appearance timing of each of the divided character strings, the popularity level indicating information relating to a usage frequency for a predetermined period of time up to a current time for each of the divided character strings; and an updating processor that updates the information relating to the character string based on the calculated popularity level.

### CROSS-REFERENCE TO RELATED APPLICATION

The present application claims priority to and incorporates by reference the entire contents of Japanese Patent Application No. 2013-170607 filed in Japan on Aug. 20, 2013.

### BACKGROUND OF THE INVENTION

1. Field of the Invention

The present invention relates to an information processing apparatus, an information updating method, and a computer-readable storage medium.

2. Description of the Related Art

In recent years, voice recognition devices that perform voice recognition processing using language models and dictionaries prepared for applications and voice recognition devices that have a learning function of the language models and the dictionaries have been used. For use in the voice recognition devices, a method has been developed that reduces false voice recognition by performing virtual voice recognition processing using input text data and updating a language model and a dictionary so as to increase a recognition rate of a falsely recognized word as the cumulative number of times of appearance of the word is larger (for example, see Japanese Patent No. 5040909).

Terms that are used in companies, industries, and the like are created newly and updated day to day. There are many cases where terms are important in operations but the cumulative numbers of times of appearances of the terms are small and the terms need to be rightly recognized particularly. In the technique disclosed in Japanese Patent No. 5040909, the language model and the dictionary are updated in accordance with the cumulative number of times of appearance of the falsely recognized word. That is, updating of the language model and the dictionary so as to increase a recognition rate of a term that is updated day to day and of which cumulative number of times of appearance is small is not performed. For this reason, the false recognition of these terms is not reduced in some cases.

The problem occurs not only in the voice recognition processing but also in processing of recognizing any input data as character information formed by character strings of a predetermined unit, such as character recognizing processing and machine translation processing.

Therefore, there is a need to reduce false voice recognition of terms that are updated day to day.

### SUMMARY OF THE INVENTION

It is an object of the present invention to at least partially solve the problems in the conventional technology.

According to an embodiment, there is provided an information processing apparatus that recognizes input data as character information formed by character strings each being in a predetermined unit based on information relating to a character string as a recognition target, and performs processing based on the recognized character information. The information processing apparatus includes an input information receiver that receives input information capable of being processed as characters; an input information dividing unit that divides the received input information into character strings each being in a predetermined processing unit; a popularity level calculating unit that calculates a popularity level based on history of an appearance timing of each of the divided character strings, the popularity level indicating information relating to a usage frequency for a predetermined period of time up to a current time for each of the divided character strings; and an updating processor that updates the information relating to the character string as the recognition target based on the calculated popularity level.

According to another embodiment, there is provided an information updating method for recognizing input data as character information formed by character strings each being in a predetermined unit based on information relating to a character string as a recognition target, and performing processing based on the recognized character information. The information updating method includes receiving input information capable of being processed as characters; dividing the received input information into character strings each being in a predetermined processing unit; calculating a popularity level based on history of an appearance timing of each of the divided character strings, the popularity level indicating information relating to a usage frequency for a predetermined period of time up to a current time for each of the divided character strings; and updating the information relating to the character string as the recognition target based on the calculated popularity level.

According to still another embodiment, there is provided a non-transitory computer-readable storage medium with an executable program stored thereon and executed by a computer. The program is for recognizing input data as character information formed by character strings each being in a predetermined unit based on information relating to a character string as a recognition target, and performing processing based on the recognized character information. The program instructs the computer to perform: receiving input information capable of being processed as characters; dividing the received input information into character strings each being in a predetermined processing unit; calculating a popularity level based on history of an appearance timing of each the divided character strings, the popularity level indicating information relating to a usage frequency for a predetermined period of time up to a current time for each of the divided character strings; and updating the information relating to the character string as the recognition target based on the calculated popularity level. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the hardware configuration of a voice recognition device according to an embodiment;

FIG. 2 is a block diagram illustrating the functional configuration of the voice recognition device in the embodiment;

FIG. 3 is a block diagram illustrating the functional configuration of a data processor in the embodiment;

FIG. 4 is a view illustrating text data in the embodiment;

FIG. 5 is a table illustrating a list of pieces of falsely recognized data in the embodiment;

FIG. 6 is a flowchart illustrating popularity level calculation processing in the embodiment;

FIG. 7 illustrates tables of pieces of data that are stored in a recognition dictionary storage unit in the embodiment;

FIG. 8 is a table illustrating an updating mode of a language model in the embodiment;

FIG. 9 is a flowchart illustrating operations of the entire voice recognition device in the embodiment;

FIG. 10 is a block diagram illustrating the functional configuration of the data processor in the embodiment; and

FIG. 11 is a view illustrating text data with marker information added in the embodiment.

### DETAILED DESCRIPTION OF THE PREFERRED EMBODIMENTS

Hereinafter, embodiments of the present invention are described in detail with reference to the drawings. In the embodiment, a voice recognition device that performs voice recognition processing on voice data has characteristics in a configuration of updating information to be used in the voice recognition processing based on data obtained by converting a document read by an image processing apparatus or the like having a scanner function into text data and the popularity level of the data. The popularity level is information relating to a usage frequency for a predetermined period of time (for example, one month) up to the current time, that is, can indicate the degree that the data has been frequently used recently regardless of the cumulative number of times of appearance.

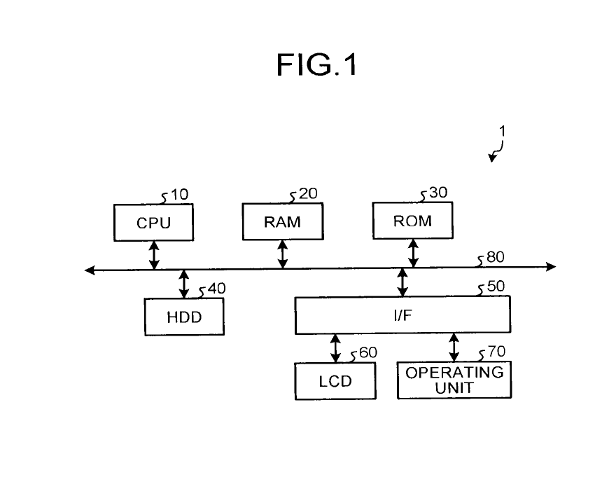

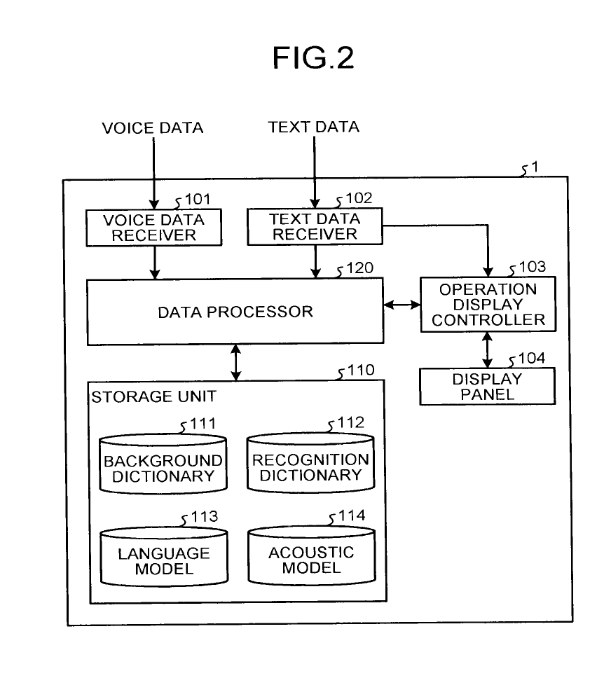

FIG. 1 is a block diagram illustrating the hardware configuration of a voice recognition device 1 in the embodiment. As illustrated in FIG. 1, the voice recognition device 1 in the embodiment has the configuration same as those of common servers, personal computers, and the like. That is to say, the voice recognition device 1 in the embodiment includes a central processing unit (CPU) 10, a random access memory (RAM) 20, a read only memory (ROM) 30, a hard disk drive (HDD) 40, and an interface (I/F) 50 that are connected through a bus 80. Furthermore, a liquid crystal display (LCD) 60 and an operating unit 70 are connected to the I/F 50. The voice recognition device 1 includes an engine for executing voice recognition processing and the like in addition to the hardware configuration as illustrated in FIG. 2.

The CPU 10 is an arithmetic unit and controls operations of the entire voice recognition device 1. The RAM 20 is a volatile storage medium capable of reading and writing information at a high speed and is used as an operation area when the CPU 10 processes the information. The ROM 30 is a read-only non-volatile storage medium and stores therein programs such as firmware. The HDD 40 is a non-volatile storage medium capable of reading and writing information and stores therein an operating system (OS), various control programs, application programs, and the like.

The I/F 50 connects the bus 80 to various pieces of hardware, networks, and the like, and controls them. The LCD 60 is a visual user interface through which a user checks a voice recognized result and the like in the voice recognition device 1. The operating unit 70 is a user interface through which the user inputs information to the voice recognition device 1, such as a keyboard and a mouse. When the voice recognition device 1 is operated as a voice recognizing server, the user interfaces including the LCD 60 and the operating unit 70 can be omitted.

In the hardware configuration, the programs stored in the ROM 30 and the HDD 40 or a recording medium such as an optical disc (not illustrated) are loaded on the RAM 20 and the CPU 10 performs operations in accordance with the programs. With this, a software controller is configured. The software controller configured in this manner and hardware are combined so as to configure a functional block executing the functions of the voice recognition device 1 in the embodiment.

Next, the functional configuration of the voice recognition device 1 in the embodiment is described. FIG. 2 is a block diagram illustrating the functional configuration of the voice recognition device 1 in the embodiment. As illustrated in FIG. 2, the voice recognition device 1 in the embodiment includes a voice data receiver 101, a text data receiver 102, an operation display controller 103, a display panel 104, a storage unit 110, and a data processor 120. The storage unit 110 includes a background dictionary storage unit 111, a recognition dictionary storage unit 112, a language model storage unit 113, and an acoustic model storage unit 114.

The respective units constituting the voice recognition device 1 are configured by combining software and hardware. To be specific, the control programs such as the firmware stored in the non-volatile storage media such as the ROM 30 and the HOD 40 are loaded on the RAM 20 and the CPU 10 performs the operations in accordance with the programs so as to configure the software controller. The software controller and the hardware such as an integrated circuit configure the respective units of the voice recognition device 1.

The voice data receiver 101 receives a voice signal input through a microphone (not illustrated) or the like as voice data as a target of the voice recognition processing and outputs it to the data processor 120. The voice data receiver 101 may acquire voice data stored in a storage medium such as a memory as the voice data as the target of the voice recognition processing.

The text data receiver 102 receives text data that is used for updating a dictionary and the like to be used for the voice recognition processing, which will be described later, and outputs it to the data processor 120. The text data is text-converted data formed by character data. For example, an optical character reader (OCR) (not illustrated) optically reads characters contained in an image read and generated by a multifunction peripheral (MFP) (not illustrated) having a scanner function, a paper document printed by a printer, or the like, and recognizes the characters, so that the text data is generated.

That is to say, the text data receiver 102 functions as an input information receiver receiving input information (text data) that can be processed as characters. The OCR may be software that is installed on the MFP and the installed OCR software may recognize the characters from the image read and generated with the scanner function of the MFP and convert the characters into the text data.

The operation display controller 103 performs information display on the display panel 104 or notifies the data processor 120 of information input through the display panel 104. The display panel 104 is an output interface for visually displaying the voice recognized result or the like by the voice recognition device 1 and an input interface (operating unit) when the user directly operates the voice recognition device 1 as the touch panel or inputs information to the voice recognition device 1.

The background dictionary storage unit 111 stores therein a background dictionary that is used for the processing in the data processor 120. The background dictionary is a dictionary formed by converting words to be used for morphological analysis by the data processor 120 into data and holds huger vocabulary than a recognition dictionary, which will be described later. The data processor 120 uses the background dictionary so as to add information such as readings to the text data as an analysis target.

The recognition dictionary storage unit 112 stores therein the recognition dictionary that is used for the processing in the data processor 120. The recognition dictionary is a dictionary formed by converting words corresponding to a category as a recognition target into pieces of data and is used for the voice recognition processing by the data processor 120 together with a language model and an acoustic model, which will be described later. The words converted into the pieces of data in the recognition dictionary are limited to words having high possibilities that they are used in the category (for example, an image processing field or a car navigation field) as the recognition target, thereby performing the voice recognition processing with higher accuracy.

The language model storage unit 113 stores therein the language model that is used for the processing in the data processor 120. The language model is data indicating appearance probabilities of words as recognition targets, connection probabilities between words and words or between sentences and sentences, and the like. For example, the language model is an N gram model. The acoustic model storage unit 114 stores therein the acoustic model that is used for the processing in the data processor 120. The acoustic model expresses relations between phonemes and characteristic amounts of the phonemes and relations between words formed by combining phonemes and characteristic amounts of the words as a statistical model. For example, a hidden Markov model (HMM) can be used as the acoustic model.

The data processor 120 performs the voice recognition processing on the voice data input from the voice data receiver 101 using the recognition dictionary stored in the recognition dictionary storage unit 112, the language model stored in the language model storage unit 113, and the acoustic model stored in the acoustic model storage unit 114. To be specific, for example, the data processor 120 calculates respective characteristic amounts from respective elements of phoneme strings of the input voice data using the acoustic model first. Then, the data processor 120 calculates words corresponding to the calculated characteristic amounts and strings of these words using the recognition dictionary and the language model. The voice recognition processing can estimate the closest vocabularies based on the input voice data and convert them into characters.

Furthermore, the data processor 120 performs virtual voice recognition processing on the text data input from the text data receiver 102 using the background dictionary stored in the background dictionary storage unit 111, the recognition dictionary stored in the recognition dictionary storage unit 112, the language model stored in the language model storage unit 113, and the acoustic model stored in the acoustic model storage unit 114. The virtual voice recognition processing is virtual voice recognition processing that is performed while the input text data is assumed to be voice data. A mode of the virtual voice recognition processing will be described later.

The data processor 120 updates the recognition dictionary and the language model based on a result of the virtual voice recognition processing and further updates the recognition dictionary and the language model based on the popularity level of the input text data. The gist in the embodiment lies in that the recognition dictionary and the language model are updated based on the popularity level of the input text data. The following describes the functional configuration of the data processor 120 in the embodiment.

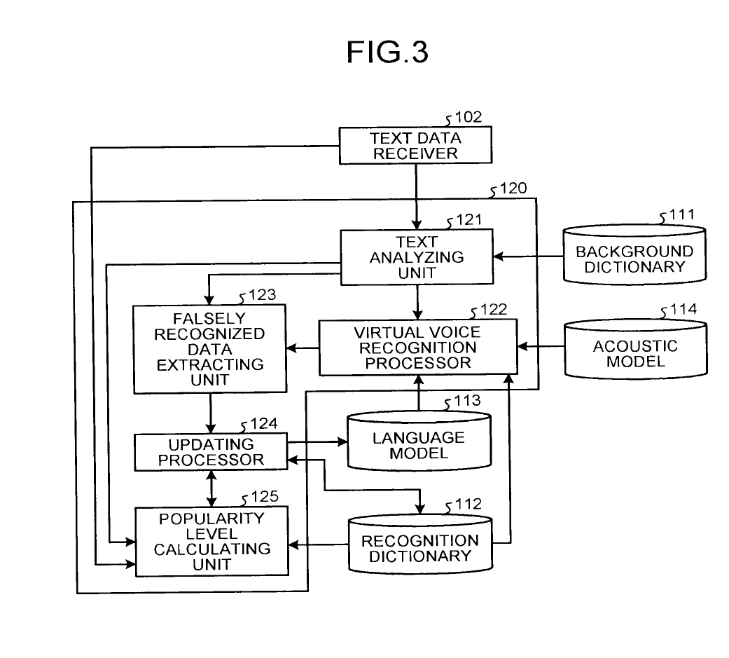

FIG. 3 is a block diagram illustrating the functional configuration of the data processor 120 in the embodiment. As illustrated in FIG. 3, the data processor 120 includes a text analyzing unit 121, a virtual voice recognition processor 122, a falsely recognized data extracting unit 123, an updating processor 124, and a popularity level calculating unit 125.

The text analyzing unit 121 performs the morphological analysis on the text data input from the text data receiver 102 using the background dictionary stored in the background dictionary storage unit 111. With this, the input text data is divided into words, and word class tags and readings expressing pronunciations of the words are added to the respective divided words. That is to say, the text analyzing unit 121 functions as an input information dividing unit that divides the text data as input information into character strings (words) of a predetermined processing unit. Hereinafter, the text data with the word class tags and the readings added to the respective divided words that have been subject to the morphological analysis is referred to as “analyzed text data”.

The virtual voice recognition processor 122 performs the virtual voice recognition processing on the analyzed text data generated by the text analyzing unit 121 using the recognition dictionary stored in the recognition dictionary storage unit 112, the language model stored in the language model storage unit 113, and the acoustic model stored in the acoustic model storage unit 114. To be specific, the virtual voice recognition processor 122 reads the analyzed text data as reading character strings with the added readings by a predetermined unit (for example, one sentence) first and converts the read reading character strings into phoneme strings based on a conversion table that is previously stored in the storage medium such as the ROM 30 and the HDD 40.

Subsequently, the virtual voice recognition processor 122 estimates the closest vocabularies from the phoneme strings converted from the analyzed text data based on the recognition dictionary, the language model, and the acoustic model and converts them into characters (words) in the same manner as the above-mentioned voice recognition processing. Hereinafter, the data converted into the characters (words) by performing the virtual voice recognition processing on the analyzed text data is referred to as “virtual recognized result data”.

The falsely recognized data extracting unit 123 extracts falsely recognized words among the words contained in the virtual recognized result data input by the virtual voice recognition processor 122. To be specific, the falsely recognized data extracting unit 123 compares the words contained in the input virtual recognized result data and the analyzed text data input from the text analyzing unit 121, and extracts sets of the words as pieces of falsely recognized data when the corresponding words are different.

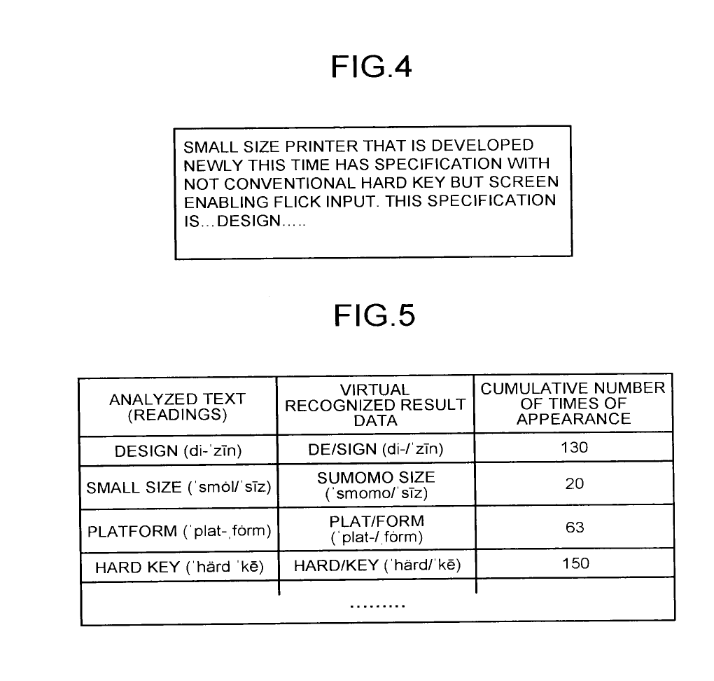

FIG. 4 is a view illustrating the text data received by the text data receiver 102. FIG. 5 is a table illustrating a list of the pieces of falsely recognized data extracted by performing the virtual voice recognition processing on the text data as illustrated in FIG. 4. As illustrated in FIG. 5, a left column in the list of the pieces of falsely recognized data indicates words in the analyzed text data corresponding to falsely recognized words, that is, right words and readings thereof that should be recognized by the virtual voice recognition processing. As illustrated in FIG. 5, “design (di- z l̅n)”, “small size (′sm\dot{o}l/′s l̅z)”, and the like contained in the text data as illustrated in FIG. 4 are right words that should be recognized by virtual recognition processing.

As illustrated in FIG. 5, the center column in the list of the pieces of falsely recognized data indicates words extracted as the pieces of falsely recognized data and the readings thereof. As illustrated in FIG. 5, for example, the word that should be recognized as “design (di- ′z l̅n)” properly is falsely recognized as “de/sign (di-/′z l̅n)” and the word that should be recognized as “small size (′smol/′s l̅z)” properly is falsely recognized as “sumomo size (′smomo/′s l̅z)”. Furthermore, as illustrated in FIG. 5, the right column in the list of the pieces of falsely recognized data indicates the cumulative numbers of times of appearances of words corresponding to the text data as illustrated in FIG. 4.

The updating processor 124 updates the recognition dictionary stored in the recognition dictionary storage unit 112 and the language model stored in the language model storage unit 113 based on the pieces of falsely recognized data input from the falsely recognized data extracting unit 123. To be specific, for example, the updating processor 124 acquires the right words contained in the pieces of input falsely recognized data sequentially, and registers, in the recognition dictionary, each word that is not registered in the recognition dictionary. Furthermore, the updating processor 124 sets the appearance probability of the word and the connection probability between the word and other words in the language model to predetermined default values.

For each word that is already registered in the recognition dictionary, the updating processor 124 changes the appearance probability of the word and the connection probability between the word and other words in the language model so as to reduce false recognition of the word (for example, increase the appearance probability and the connection probability). Furthermore, the updating processor 124 may control a change amount of the appearance probability of each word and the connection probability thereof in the language model in accordance with the cumulative number of times of appearance of the falsely recognized data that has been input. When the cumulative number of times of appearance of the word is smaller than a predetermined threshold, the updating processor 124 may not update the recognition dictionary and the language model for the word.

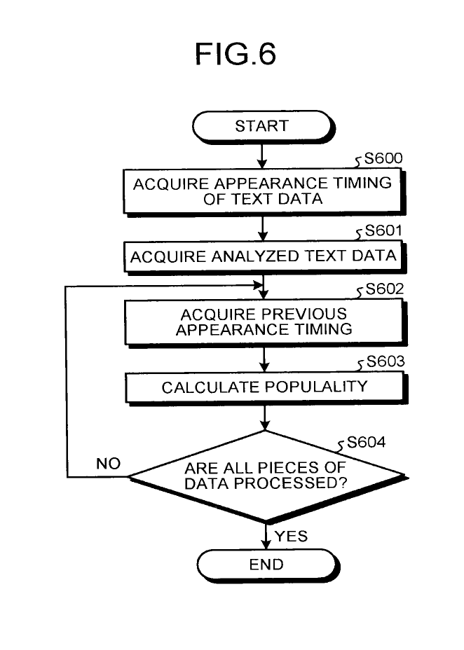

The popularity level calculating unit 125 calculates the popularity levels of the respective words contained in the text data received by the text data receiver 102 based on histories of appearance timings for the respective words. The following describes the popularity level calculation processing by the popularity level calculating unit 125 with reference to FIG. 6. FIG. 6 is a flowchart illustrating the popularity level calculation processing by the popularity level calculating unit 125. As illustrated in FIG. 6, the popularity level calculating unit 125 acquires the time and date at which the text data has been received from the text data receiver 102 as the appearance timing of the text data (S600). The appearance timing of the text data may be time and date at which a read image of a document as an original of the text data has been generated, time and date at which a document as the original of the text data has been printed, time and date at which a document as the original of the text data has been created, or the like.

The popularity level calculating unit 125 that has acquired the appearance timing of the text data acquires the analyzed text data input from the text analyzing unit 121 (S601). The popularity level calculating unit 125 that has acquired the analyzed text data acquires a previous appearance timing of each of the divided words contained in the acquired analyzed text data (S602). The previous appearance timing is the latest appearance timing of a corresponding word contained in text data received before the appearance timing at which the text data receiver 102 has acquired at S600, and is stored in the recognition dictionary storage unit 112 so as to correspond to a word contained in the recognition dictionary, for example.

For example, when the appearance timing of the word “design” contained in the previously received text data is “7/1 14:50”, “7/1 14:50” is stored in the recognition dictionary storage unit 112 as the previous appearance timing so as to correspond to the word of “design” contained in the recognition dictionary. Among the words contained in the text data that the text data receiver 102 has received at this time, each word registered in the recognition dictionary by the updating processing that is performed by the updating processor 124 based on the falsely recognized data does not have information about the previous appearance timing. For this reason, the previous appearance timing corresponding to the word is blank.

The popularity level calculating unit 125 that has acquired the previous appearance timing of the word as a popularity level calculation target calculates the popularity level of the target word based on the acquired previous appearance timing and the appearance timing acquired at S600 (S603). To be specific, the popularity level calculating unit 125 calculates a difference (for example, on a minute basis) between the previous appearance timing and the appearance timing acquired at S600 as the popularity level of the target word. For example, when the previous appearance timing of the target word “design” is “7/1 14:50” and the appearance timing acquired at S600 is “7/1 15:00”, the popularity level of the word “design” is “10”. Thus, an interval from the time at which the word “design” has appeared at the previous time to the time at which it has appeared at this time is short and it is considered that the usage frequency thereof has become high recently. Based on this, the value indicating the popularity level is small (that is, the popularity level is high). When the previous appearance timing is blank, the popularity level of the word is set to “0”.

Then, the popularity level calculating unit 125 repeats the pieces of processing at S602 and S603 for an unprocessed word (No at S604) until all the words contained in the acquired analyzed text data are subject to the pieces of processing at S602 and S603 completely (Yes at S604).

The updating processor 124 updates the recognition dictionary stored in the recognition dictionary storage unit 112 based on the popularity levels and the appearance timings of the respective words that have been input from the popularity level calculating unit 125. To be specific, for example, the updating processor 124 stores and updates the input popularity levels of the respective words in the recognition dictionary storage unit 112 so as to correspond to the words contained in the recognition dictionary, and updates the previous appearance timings stored so as to correspond to the words having the updated popularity levels to the input appearance timings. Although the previous appearance timings and the popularity levels are stored in the recognition dictionary storage unit 112 in the embodiment as an example, they may be stored in another storage medium so as to correspond to the words contained in the recognition dictionary.

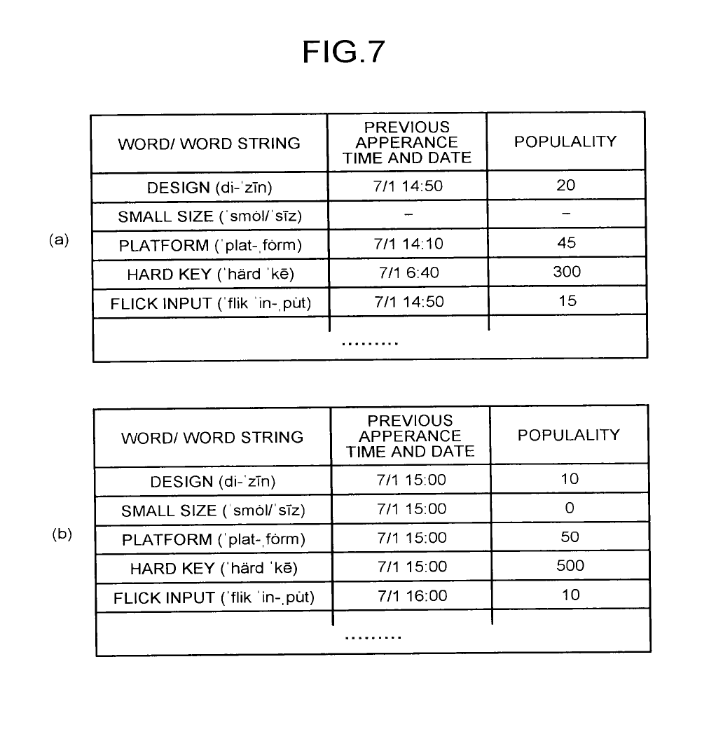

In FIG. 7, (a) illustrates a list of the previous appearance timings and the popularity levels corresponding to the respective words before updated by the updating processor 124 that are stored in the recognition dictionary storage unit 112, and (b) illustrates a list of the previous appearance timings and the popularity levels corresponding to the respective words after updated by the updating processor 124. As illustrated in (a) in FIG. 7, there are “design”, “platform”, “hard key”, “flick input”, and the like as the words contained in the analyzed text data received at S601 in FIG. 6. The previous appearance timings and the previously calculated popularity levels of the respective words are stored so as to correspond to the respective words. Furthermore, “small size” is a word appeared for the first time at this time, so that the previous appearance timing and the popularity level therefor are marked with “-”.

The updating processor 124 updates the popularity levels of the respective words by the above-mentioned updating processing as illustrated in (b) in FIG. 7 and updates the previous appearance timings of the respective words to the appearance timings (7/1 15:00 in (b) in FIG. 7) input from the popularity level calculating unit 125. As illustrated in (b) in FIG. 7, “small size” is the word appeared for the first time at this time, so that the popularity level therefor is “0”.

Furthermore, the updating processor 124 updates the language model stored in the language model storage unit 113 based on the popularity levels of the respective words that have been input from the popularity level calculating unit 125. To be specific, for example, the updating processor 124 changes the appearance probabilities of the words and the connection probabilities between the words and other words so as to increase the recognition rates of the words based on the popularity levels of the respective input words. For example, the updating processor 124 increases the appearance probability and the connection probability of a word as the popularity level of the word is higher (in the embodiment, a value indicating the popularity level is smaller). Although the value indicating the popularity level of the word appeared for the first time is “0” in the embodiment, the value may be set to predetermined another value.

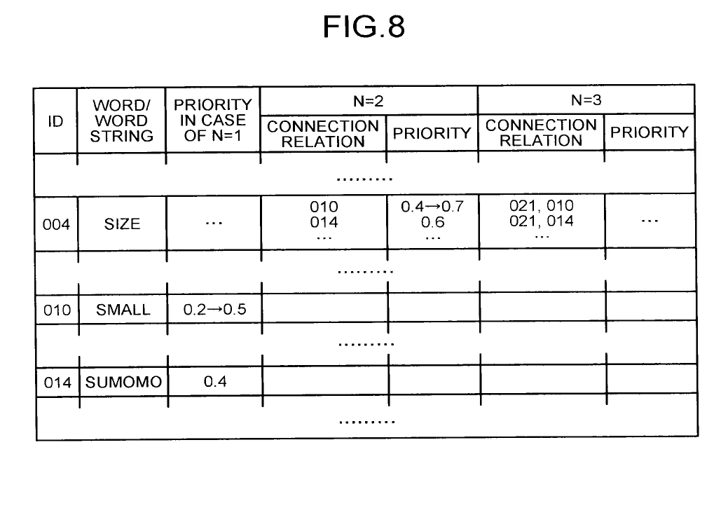

FIG. 8 is a table illustrating an updating mode of the language model stored in the language model storage unit 113. As illustrated in FIG. 8, the appearance probability of the word and the connection probability between the word and other words in the language model can be expressed by priority and it can be interpreted as a probability value in the N gram model. Accordingly, the priority (probability value) in the case of N=1 is the appearance probability of each word when a string of the words is neglected. For example, the appearance probability of “small” of which ID is “010” before updating is 0.2.

The priority (probability value) in the case of N=2 is a conditional appearance probability of the word when one previous word is assumed to be history. For example, as illustrated in FIG. 8, “small” of which ID is “010” is connected just before “size” as a connection relation in the case of N=2, and the conditional appearance probability before updating for the connection relation is 0.4. Furthermore, the priority (probability value) in the case of N=3 is a conditional probability of the word when the two previous words are assumed to be history.

For example, when the popularity level of “small size” is “0”, the updating processor 124 updates so as to increase the appearance probability of “small” and the connection probability that “small” and “size” are connected. As a result, as illustrated in FIG. 8, for example, the priority of “small” in the case of N=1 is updated from 0.2 to 0.5, and the priority of the connection relation between “size” and “small” in the case of N=2 is updated from 0.4 to 0.7. With this, the appearance probability of “small” is higher than that of “sumomo”, and the connection probability of the connection relation between “small” and “size” is higher than the connection probability of that between “sumomo” and “size”. This can reduce the possibility that “small size” is falsely recognized as “sumomo size” as illustrated in FIG. 5.

Although the updating processor 124 updates the priorities of the respective words and the connection relations based on the popularity levels as an example in the above-mentioned embodiment, the popularity levels may be used instead of the priorities. In this case, as the value indicating the popularity level is smaller, the appearance probability and the connection probability are higher. Furthermore, the updating processor 124 may update so as to increase the priority of the target word (for example, “small”) in accordance with the popularity level and decrease the priority of the word (for example, “sumomo”) that is easy to be falsely recognized. Alternatively, the updating processor 124 may update so as to decrease the priority that is easy to be falsely recognized only.

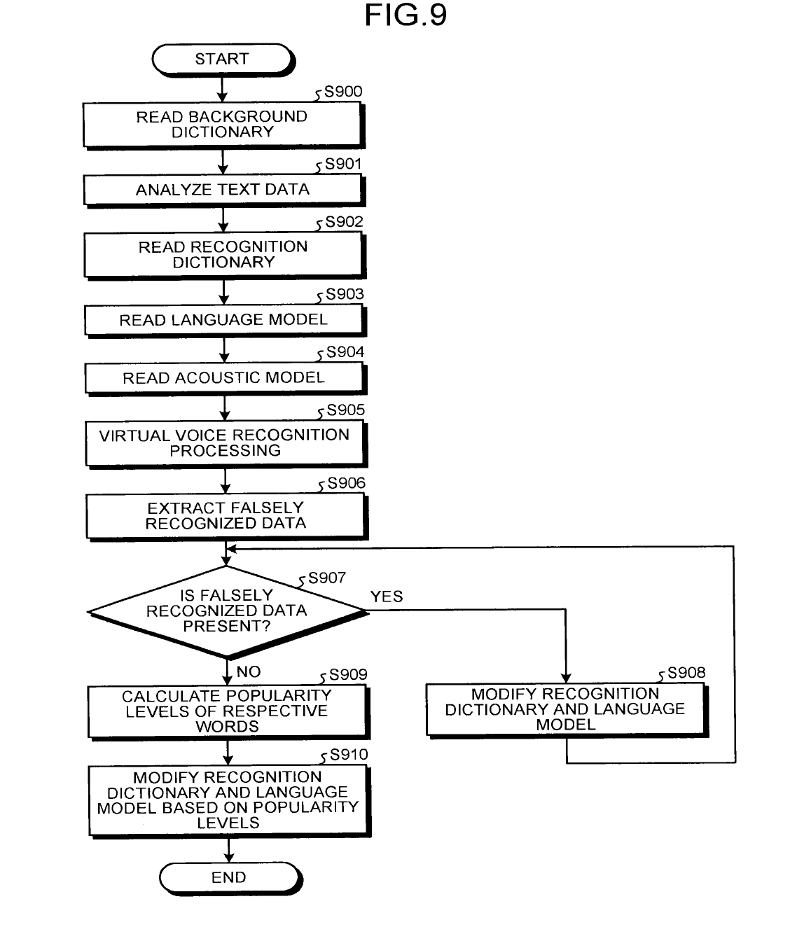

Next, operations of the entire voice recognition device 1 in the embodiment are described. FIG. 9 is a flowchart illustrating the operations of the entire voice recognition device 1 in the embodiment. As illustrated in FIG. 9, when the text data receiver 102 receives the text data, the text analyzing unit 121 reads the background dictionary stored in the background dictionary storage unit 111 (S900). The text analyzing unit 121 that has read the background dictionary analyzes the text data received by the text data receiver 102 using the read background dictionary, generates analyzed text data, and outputs it to the virtual voice recognition processor 122 (S901).

The virtual voice recognition processor 122 that has received the analyzed text data input from the text analyzing unit 121 reads the recognition dictionary stored in the recognition dictionary storage unit 112 (S902), reads the language model stored in the language model storage unit 113 (S903), and reads the acoustic model stored in the acoustic model storage unit 114 (S904). The virtual voice recognition processor 122 that has read the recognition dictionary, the language model, and the acoustic model performs the above-mentioned virtual voice recognition processing on the analyzed text data input from the text analyzing unit 121 using the read recognition dictionary, language model, and acoustic model, and outputs the virtual recognized result data to the falsely recognized data extracting unit 123 (S905).

The falsely recognized data extracting unit 123 that has received the virtual recognized result data input from the virtual voice recognition processor 122 extracts the falsely recognized data from the input virtual recognized result data (S906). When a falsely recognized word is present (Yes at S907), the updating processor 124 updates the recognition dictionary and the language model based on the falsely recognized word (S908).

On the other hand, when the falsely recognized word is not present or the recognition dictionary and the language model have been updated for all the falsely recognized words (No at S907), the popularity level calculating unit 125 calculates the popularity levels of the respective words contained in the analyzed text data generated by the text analyzing unit 121 at S901 and outputs them to the updating processor 124 (S909). The updating processor 124 that has received the popularity levels of the respective words input from the popularity level calculating unit 125 updates the recognition dictionary and the language model based on the input popularity levels of the respective words (S910).

With this, as described above with reference to FIG. 9, for example, when the popularity level of “small size” is “0”, the updating processor 124 updates so as to increase the appearance probability of “small” and the connection probability that “small” and “size” are connected. As a result, the appearance probability of “small” is higher than that of “sumomo” and the connection probability that “small” and “size” are connected is higher than the connection probability that “sumomo” and “size” are connected. This can reduce the possibility that “small size” is falsely recognized as “sumomo size” as illustrated in FIG. 5.

As described above, the voice recognition device 1 in the embodiment divides the input text data into words, calculates the popularity levels of the respective divided words, and updates the language model and the recognition dictionary based on the calculated popularity levels of the respective words. This enables the language model and the recognition dictionary to be updated so as to increase the recognition rates of the words of which cumulative numbers of times of appearances are small but that are started to be used recently, that is, the words having high popularity levels rather than words of which cumulative numbers of times of appearances are large but that are not used recently. This can reduce false voice recognition of the terms that are updated day to day.

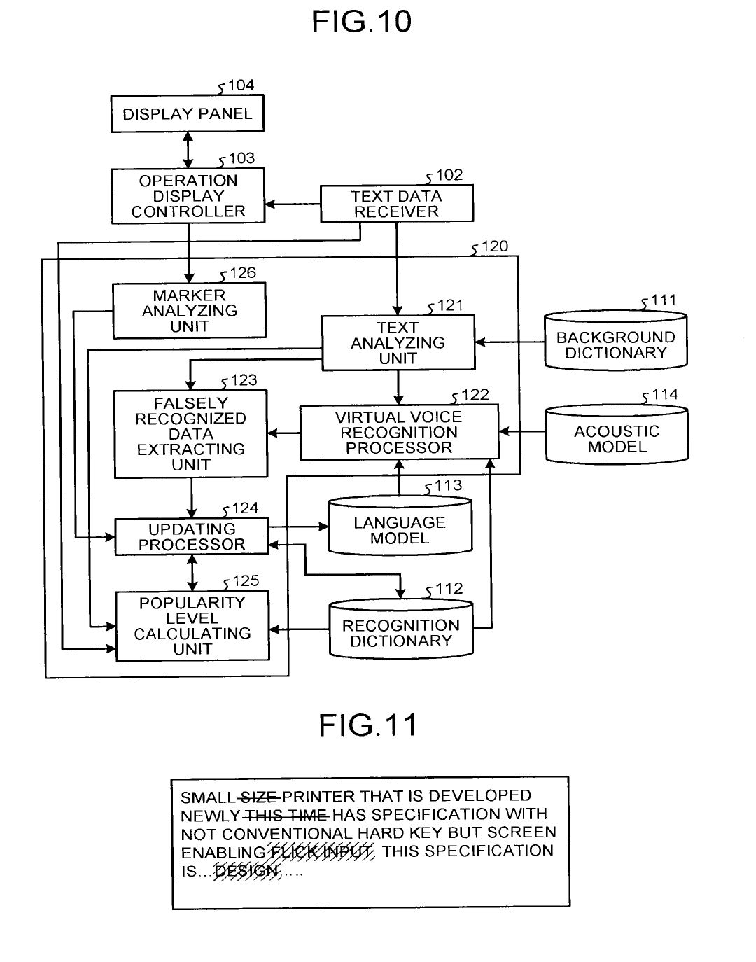

Next, an embodiment in which the user weighs the popularity level is described. FIG. 10 is a diagram illustrating the functional configuration of the data processor 120 for causing the user to weigh the popularity level. As illustrated in FIG. 10, the data processor 120 in the embodiment has a configuration including a marker analyzing unit 126 in addition to the respective units as illustrated in FIG. 3. Hereinafter, description of constituent parts that perform the same operations as those in the embodiment as described above with reference to FIG. 3 are omitted and constituent parts that perform different operations are described.

The marker analyzing unit 126 receives text data with marker information added by the user, extracts a word with the marker information added, and outputs the extracted word and the marker information added to the word to the popularity level calculating unit 125. The marker information is additional information for distinguishing property of the word, such as a word that needs not be recognized and an important word. That is to say, the marker analyzing unit 126 functions as an additional information analyzing unit that analyzes the additional information. For example, when the text data receiver 102 receives the text data, the text data is displayed on the display panel 104 under control by the operation display controller 103. The user performs an operation of adding the marker information using fingers, a touch pen, a mouse, a keyboard, or the like on the display panel 104 displaying the text data.

FIG. 11 is a view illustrating the text data displayed on the display panel 104. As illustrated in FIG. 11, the marker information is added to the text data with the operation of adding the marker information by the user. For example, portions with strike-through, such as a portion “this time” and a portion “size” in “small size”, indicate that words in the portions need not be recognized. In addition, for example, portions with a predetermined color (in FIG. 11, indicated by shading), such as a portion “flick input” and a portion “design”, indicate that words in the portions are important.

The updating processor 124 updates the recognition dictionary stored in the recognition dictionary storage unit 112 and the language model stored in the language model storage unit 113 based on the word and the marker information added to the word that have been input from the marker analyzing unit 126. For example, the updating processor 124 weighs the popularity level of the word input from the marker analyzing unit 126 among the popularity levels of the respective words input from the popularity level calculating unit 125 based on the marker information added to the word, and modifies the recognition dictionary and the language model based on the weighed popularity level.

For example, when marker information indicating an important word is added to a word, the updating processor 124 weighs so as to increase the popularity level of the word (decrease the value indicating the popularity level). That is to say, the language model is updated so as to increase the recognition rate of the word with the added marker information indicating the important word.

On the other hand, for example, when marker information indicating that a word needs not be recognized is added to a word, the updating processor 124 deletes the word with the added marker information from the recognition dictionary and the language model. In addition, the updating processor 124 may decrease the popularity level of the word (increase the value indicating the popularity level) in accordance with the types of the added marker information.

The appearance probability of the word and the connection probability between the word and other words are changed so as to increase the recognition rate of the word based on the popularity level of the word in the above-mentioned embodiment, as an example. In addition, when the popularity level of the word is lower than a predetermined level (that is, the value indicating the popularity level is larger than a predetermined threshold in the embodiment), the word may be deleted from the recognition dictionary and the language model. This can prevent false recognition between the word that has not been used and other words and can reduce memory consumption of a storage region for storing the recognition dictionary and the language model.

On the other hand, when the cumulative number of times of appearance of the word is large even if the popularity level thereof is low, the word may be excluded from the deletion target. In this case, the updating processor 124 causes the recognition dictionary storage unit 112 to store therein the cumulative number of times of appearance of the word together with the popularity level thereof. When the cumulative number of times of appearance of the word is larger than the predetermined number of times even if the popularity level thereof is low, the updating processor 124 updates the recognition dictionary and the language model while prohibiting the deletion of the word. This can prevent the false recognition from being generated due to absence of the word in the recognition dictionary and the like when the word that has not been used currently but is possibly used again in consideration of the cumulative number of times of appearance is used again. In this case, not only the popularity level of the word but also the cumulative number of times of appearance thereof may be weighted based on the marker information added by the user.

In the above-mentioned embodiment, the recognition dictionary for each user may be stored in the recognition dictionary storage unit 112 and the language model for each user may be stored in the language model storage unit 113. In this case, for example, the updating processor 124 acquires the user information input from the display panel 104 when the user logs in the voice recognition device 1, and updates the recognition dictionary and the language model for the user corresponding to the acquired user information in the updating processing. This enables the recognition dictionary and the language model to be updated based on the text data provided by the user, thereby providing a recognized result with higher accuracy in accordance with a usage condition of each user. Furthermore, there may be the recognition dictionary and the language model for not only each user but also each group to which a plurality of users belong.

Furthermore, in the above-mentioned embodiment, the configuration in which MFPs and printers outputting read image, a print paper, or the like as an original of text data as an analysis target are classified into groups, recognition dictionaries for the respective groups are stored in the recognition dictionary storage unit 112, and language models for the respective groups are stored in the language model storage unit 113 may be employed. With this configuration, when apparatuses that are used in the same operation are classified into the same group, the recognition dictionary and the language model of the words that are used in the same operation are updated in many cases. This can establish the recognition dictionary and the language model that are more appropriate for the operation.

Furthermore, in the above-mentioned embodiment, the popularity level calculating unit 125 calculates, as the popularity levels, values of the differences between the appearance timings of the respective words in the text data and the previous appearance timings of the respective words. This is merely an example, and the popularity level calculating unit 125 may calculate, as the popularity levels, the numbers of times of appearances for a predetermined period of time (for example, one month) up to the current time. In this case, the popularity level is higher as the latest number of times of appearance is larger regardless of the cumulative number of times of appearance. That is, the language model is updated so as to increase the recognition rate of the word as the number of times of appearance thereof in this period is larger.

In the above-mentioned embodiment, the unit for various pieces of processing including the unit by which the text analyzing unit 121 divides the text data, the unit by which the falsely recognized data extracting unit 123 extracts as the falsely recognized data, and the unit by which the popularity level is calculated is a word as an example. The word as the unit is merely an example and it is sufficient that the unit is a character string of a predetermined processing unit, such as a string of a plurality of words and a block phrase.

In the above-mentioned embodiment, first, the virtual voice recognition processing is performed based on the input text data and the recognition dictionary and the language model are updated based on the extracted falsely recognized data. Subsequently, the popularity levels of words contained in the input text data are calculated and the recognition dictionary and the language model are further updated based on the calculated popularity levels. The updating processing (that is, S902 to S908 in FIG. 9) based on the falsely recognized data extracted by the virtual voice recognition processing can be omitted. In this case, the updating processor 124 registers a word(s) that is(are) not stored in the recognition dictionary among the words of which popularity levels have been calculated by the popularity level calculating unit 125.

Furthermore, in this case, the recognition dictionary and the language model are updated based on the popularity levels of the words contained in the input text data. With this, the embodiment can be also applied to not only updating of the recognition dictionary and the language model that are used for the voice recognition processing but also updating of information relating to a character string as a recognition target, such as a dictionary and a language model, when any input data such as text data and voice data is recognized as character information formed by character strings of a predetermined unit and processing is performed based on the recognized character information as in character recognizing processing and machine translation processing.

In the above-mentioned embodiment, the voice recognition device 1 includes the background dictionary storage unit 111, the recognition dictionary storage unit 112, the language model storage unit 113, and the acoustic model storage unit 114, as an example, as described above with reference to FIG. 2. The gist in the embodiment lies in that the recognition dictionary and the language model are updated based on the popularity levels of the words contained in the input text data. Accordingly, the background dictionary storage unit 111, the recognition dictionary storage unit 112, the language model storage unit 113, and the acoustic model storage unit 114 may be provided at the outside of the voice recognition device 1.

For example, the background dictionary storage unit 111, the recognition dictionary storage unit 112, the language model storage unit 113, and the acoustic model storage unit 114 are provided on a server connected to the voice recognition device 1 through a network and the data processor 120 accesses the server through the network so as to access dictionaries of various types and models. This can perform the pieces of processing that are same as those in the above-mentioned embodiment.

According to the invention, false of voice recognition of terms that are updated day to day can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that recognizes input data as character information formed by character strings each being in a predetermined unit based on information relating to a character string as a recognition target, and performs processing based on the recognized character information, the information processing apparatus comprising:
an input information receiver that receives input information capable of being processed as characters;
an input information dividing unit that divides the received input information into character strings each being in a predetermined processing unit;
a popularity level calculating unit that calculates a popularity level based on history of an appearance timing of each of the divided character strings, the popularity level indicating information relating to a usage frequency for a predetermined period of time up to a current time for each of the divided character strings; and
an updating processor that updates the information relating to the character string as the recognition target based on the calculated popularity level.

2. The information processing apparatus according to claim 1, further comprising an additional information analyzing unit that analyzes additional information added to a character string contained in the received input information, wherein
the updating processor updates the information relating to the character string as the recognition target based on the calculated popularity level and an analysis result of the additional information.

3. The information processing apparatus according to claim 2, wherein the updating processor weighs the calculated popularity level in accordance with the analysis result of the additional information and updates the information relating to the character string as the recognition target based on the weighed popularity level.

4. The information processing apparatus according to claim 2, wherein the updating processor excludes the character string with the additional information added from the information relating to the character string as the recognition target based on the analysis result of the additional information.

5. The information processing apparatus according to claim 1, wherein the popularity level calculating unit calculates, as the popularity level, a difference between time indicating the appearance timing of each of the divided character strings and time indicating a latest appearance timing of the same character string divided from the input information received before the appearance timing.

6. The information processing apparatus according to claim 5, wherein the updating processor updates the information relating to the character string as the recognition target such that as the difference indicating the popularity level is smaller, a recognition rate of the character string having the popularity level is higher.

7. The information processing apparatus according to claim 5, wherein when the difference indicating the popularity level is larger than a predetermined value and cumulative number of times of appearance of the character string having the popularity level is larger than a predetermined number of times, the updating processor prohibits exclusion of the character string having the popularity level from the information relating to the character string as the recognition target.

8. The information processing apparatus according to claim 1, wherein the updating processor updates the information relating to the character string as the recognition target for each user based on the input information provided by the user.

9. An information updating method for recognizing input data as character information formed by character strings each being in a predetermined unit based on information relating to a character string as a recognition target, and performing processing based on the recognized character information, the information updating method comprising:
receiving input information capable of being processed as characters;
dividing the received input information into character strings each being in a predetermined processing unit;
calculating a popularity level based on history of an appearance timing of each of the divided character strings, the popularity level indicating information relating to a usage frequency for a predetermined period of time up to a current time for each of the divided character strings; and
updating the information relating to the character string as the recognition target based on the calculated popularity level.

10. A non-transitory computer-readable storage medium with an executable program stored thereon and executed by a computer, wherein the program is for recognizing input data as character information formed by character strings each being in a predetermined unit based on information relating to a character string as a recognition target, and performing processing based on the recognized character information, and the program instructs the computer to perform:
receiving input information capable of being processed as characters;
dividing the received input information into character strings each being in a predetermined processing unit;
calculating a popularity level based on history of an appearance timing of each of the divided character strings, the popularity level indicating information relating to a usage frequency for a predetermined period of time up to a current time for each of the divided character strings; and
updating the information relating to the character string as the recognition target based on the calculated popularity level.
